(19) United States
(12) Patent Application Publication
(10) Pub. No.: US 2013/0155031 A1
(43) Pub. Date: Jun. 20, 2013

(54) USER CONTROL OF ELECTRONIC DEVICES

(71) Applicants: Tobias Dahl, Oslo (NO); Elad Shabtai, Drobak (NO)

(72) Inventors: Tobias Dahl, Oslo (NO); Elad Shabtai, Drobak (NO)

(73) Assignee: ELLIPTIC LABORATORIES AS, Olso (NO)

(21) Appl. No.: 13/806,129

(22) PCT Filed: Jun. 29, 2011
(86) PCT No.: PCT/GB2011/051231

§ 371 Date: Feb. 26, 2013

(30) Foreign Application Priority Data
Jun. 29, 2010 (GB) 1010953.6
Jan. 6, 2011 (GB) 1100153.4

(51) Int. Cl. G06F 3/041; G06F 3/043

(52) U.S. Cl. CPC G06F 3/0412; G06F 3/043
USPC 345/177; 345/173

(57) ABSTRACT

An electronic device (2; 26) comprises a first input means adapted to detect that a first digit of a user's hand (6; 28) is in contact with the device and a second input means adapted to detect movement of a second digit 30 of the user's hand which is not in contact with the device. The device is configured to respond to detection of the movement by the second input means while the contact is detected by the first input means or within a predetermined mined time thereafter.

There are a growing number of electronic devices available in the market today and they are growing in sophistication. On the other hand, there is a growing need and awareness amongst users for simple and intuitive ways to interact with these devices in order to allow them to be controlled. Increasingly, consumers simply will not accept complex and fiddly commands and menu structures for operating each device, particularly where these differ between devices and where devices tend to have a relatively short lifespan.

There has in recent years been a rapid increase in the availability of, and demand for, devices which are operated by means of a touch-screen. However, particularly in the case of smaller hand-held devices such as smart phones it can be difficult to provide for a sufficient number of user inputs in the limited space available whilst still allowing the device reliably to discriminate the user's intended input from other possible inputs.

In recent years advances have been made which allow the deployment of a touch-screen which can sense and respond to multiple simultaneous touches from a user's fingers to extend the range of possible inputs, but it may not always be desirable to use such a multi-touch-screen either because of the increased cost or for other reasons.

When viewed from a first aspect the present invention provides an electronic device comprising: a first input means adapted to detect that a first digit of a user's hand is in contact with the device; and a second input means adapted to detect movement of a second digit of the user's hand which is not in contact with the device, wherein the device is configured to respond to detection of said movement by said second input means while said contact is detected by said first input means or within a predetermined time thereafter.

The invention extends to a method of operating an electronic device comprising detecting that a first digit of a user's hand is in contact with the device using a first input means; detecting movement of a second digit of the user's hand which is not in contact with the device using a second input means, and responding to detection of said movement by said second input means while said contact is detected by said first input means or within a predetermined time thereafter.

The invention further extends to computer software, and to such software on a carrier, which is adapted, when run on suitable data processing means, to:
receive a first signal from a first input means of an electronic device indicating a detection that a first digit of a user's hand is in contact with the device;
receive a first signal from a second input means of the electronic device indicating a detection of a movement of a second digit of a user's hand which is not in contact with the device; and
provide a response in the event that said movement of the user's second digit is detected while said contact by the first digit is detected or within a predetermined time thereafter.

Thus it will be seen by those skilled in the art that in accordance with the invention there is provided an arrangement which extends the range of possible inputs for an electronic device by introducing movement detection for a user's finger or thumb while another finger or thumb is touching the device or shortly afterwards. Even if motion detection is a crude detection of the presence or absence of motion of the second digit, the number of possible inputs is doubled as compared to those available from the first ‘touch’ input means alone. Equally the invention may be implemented to extend the functionality of a touchless device by giving different functions upon the device being touched. For example the device may be configured to recognise a leftward or rightward sweeping hand gesture to operate a sliding control or move along a string of images, but when the screen is touched the same gesture (performed during or after the touch) might cause an image to expand or contract or rotate.

Moreover there is an advantage in the fact that the touchless detection of the movement of the second digit is only required when a touch has been detected. This significantly reduces the potential for accidental detections of movements that were not intended to be inputs to the device. This might allow the second input means to be made more sensitive than would otherwise be the case.

In a set of preferred embodiments the detections by the first and second input means are simultaneous—i.e. the device will respond to motion of the second digit only while the first digit is in contact with the device. However the invention also includes the possibility of the detection of the second digit movement happening within a predetermined time after contact by the first digit. This time could be measured from when the contact is first detected but is preferably measured from when contact is no longer detected. The time window may be chosen to suit the application—e.g. 0.5 seconds or a second.

There are a number of options for the first input means which is adapted to detect contact by the user's first digit. In one set of embodiments, the first input means comprises a physical or virtual button which detects pressure or touch from a user's finger in a single place. In another set of embodiments, the first input means comprises a touch-pad or touch-screen which is able to detect the location of the user's touch. In a preferred set of embodiments, the first input means comprises a touch-pad with an integrated display screen i.e. a touch-screen. The touch-screen or touch-pad could be one which is only able to register a single point of contact at any given time (single touch) or one which is capable of detecting more than one point of contact at a time (multi-touch). The invention may advantageously be applied where only a ‘single touch’ screen is provided in a device since it allows additional and more varied input without having to upgrade the hardware.

In a set of embodiments the device is configured to respond differently to a given movement of the second digit depending on the nature of the contact by the first digit. For example the duration of contact could influence the response, e.g. a short tap indicating one set of functions and a long press indicating another. Additionally or alternatively the location of the contact could influence the input. Additionally or alternatively the number of contacts—either simultaneous or successive—could influence the input. For example a single tap could indicate a different set of functions to a double tap, or contact by a further digit at the same time as the first digit could indicate different functions if the touch-sensitive .part of the device is multi-touch enabled. In the example given earlier of a sweeping gesture panning along a string of images, a single tap preceding the gesture could activate zooming, while a double-tap could activate brightness control. Of course the difference in response to a given (touchless) movement could comprise enabling or disabling that movement as a valid input. For example when scrolling a string of images using a left-right gesture, touching the screen could indicate that zooming is now allowed which is controlled using an up-down gesture.

The motion of the second digit could be detected by any suitable means but in a set of preferred embodiments, this motion is detected by receipt of an acoustic signal reflected from the second digit. In one set of embodiments the signal is ultrasonic, i.e. it has a frequency greater than 20 kHz e.g. between 30 and 50 kHz. In a convenient set of embodiments, the transmitter and/or receiver, preferably both of them, is also used by the device for transmission/reception of audible signals. This means that the standard microphone and/or speaker(s) of the device, which might e.g. be a smart phone, can advantageously be employed since these will typically be operable at ultrasound frequencies even if not necessarily intended for this. It will be appreciated that this gives a particularly attractive arrangement since it opens up the possibility of providing the additional input functionality described herein to an electronic device without having to add any additional hardware. In another set of embodiments lower frequency acoustic signals could be used, e.g. with a frequency of 17 kHz or greater which may not be audible to most people. Use could even be made of signals which are clearly in the audible range, recognising that in accordance with preferred embodiments of the invention the signals are only transmitted at most for as long as the user is touching the device. In fact the sound could be used positively as an indication that a composite input of the type discussed herein is available.

The device may be configured to detect movement of just the second digit or may detect such movement as part of an overall movement of the hand. This is more likely to be applicable where the movement is carried out within a short time after the first digit contact rather than during such contact.

When viewed from a further aspect the invention provides an electronic device comprising: a first input means adapted to detect that at least part of a user's hand is in contact with the device; and a second input means adapted to detect movement of at least part of a user's hand which is not in contact with the device, wherein the device is configured to respond to detection of said movement by said second input means differently depending on whether said contact with the device is detected by said first input means before said movement is detected.

In a set of embodiments in accordance with the invention, which may well include many examples of those mentioned above in which the existing microphone and speaker are employed, motion detection can be carried out using just a single channel i.e. one transmitter-receiver pair. Whilst this would not normally be considered sufficient for a touchless movement or gesture recognition system, the Applicant has recognised that this is sufficient for the detection of crude movements, particularly in the context of the present invention where motion detection is only required when a digit on the same hand is touching the device. This significantly simplifies the detection problem space because the motion detection zone can be very small and well defined since it can be related to the dimensions of a human hand.

Moreover, since motion detection is only required when a particular physical touch is detected, the ultrasonic signal transmission and corresponding processing of received signals need only be carried out for very short periods of time which lead to a significant saving in energy consumption over a system where detection signals are transmitted all the time. In a set of preferred embodiments the device is configured only to transmit the signal when the physical contact is detected by the first input means. In some embodiments the device could be configured so as not to transmit once the motion of the second digit had been detected. Preferably however transmission continues until the first input means no longer detects contact by the first digit. This allows multiple successive inputs to be received. Where the movement detection can be made within a predetermined time after the contact clearly transmission will need to take place during this time.

Similarly In a set of preferred embodiments the device is configured only to process signals received by the receiver when the physical contact is detected by the first input means.

The transmission could take any convenient form. In a simple embodiment it takes the form of a series of discrete transmissions. Each such transmission could comprise a single impulse or spike, i.e. approximating a Dirac delta function within the limitations of the available bandwidth. This has some advantages in terms of requiring little, if any, processing of the ‘raw signal’ to calculate impulse responses (in the theoretical case of a pure impulse, no calculation is required) but gives a poor signal-to-noise ratio because of the deliberately short transmission. In other embodiments the transmit signals could be composed of a series or train of pulses. This gives a better signal-to-noise ratio than a single pulse without greatly increasing the computation required. In other embodiments the transmit signals comprise one or more chirps—i.e. a signal with rising or falling frequency. These give a good signal-to-noise ratio and are reasonable for calculating the impulse responses using a corresponding de-chirp function applied to the ‘raw’ received signal. In other embodiments a pseudo-random codes—e.g. a Maximum Length Sequence pseudo-random binary code could be used. In a set of embodiments a continuous transmission (during the relatively limited transmission window) can be employed.

There are a variety of ways in which a reflected ultrasonic signal can be used to detect motion of the second digit. The motion could be detected using the frequency of the received signal—e.g. detecting a Doppler shift or more complex change in the frequency spectrum. Additionally or alternatively, the signal received from two or more consecutive transmissions or periods of transmission may be analysed for a particular trend. The “raw” received signal could be used or the impulse response could be calculated. A filter such as a line filter could then be applied on either the raw signal or the impulse responses in order to detect particular motions. A single line filter could be used or a plurality could be used e.g. looking for the best match. Further details of such arrangements are disclosed in WO 2009/115799.

The motion of the second digit which is detected in accordance with the invention could take a number of forms. Most simplistically, as mentioned above, there may simply be a detection of the presence or absence of motion. In another set of embodiments, a rotary motion of the second digit around the first digit is detected; in other words the device is adapted to detect a “touch and twist” motion. The motion could be detected together with its direction such that motion in each direction gives a different input. In another set of embodiments, a movement of the second digit in the direction towards or away from the first digit is detected. In one example of the use of these motions, a simple, natural thumb-click motion may be detected while the user's index finger is touching the device. This allows a “virtual thumb-click” to be added to a touch-operated device, thereby extending its input functionality.

The Applicant has also recognised that in cases where the intended input gesture is executed by a single hand and the first input means comprises a touch-pad or touch-screen, the device can exploit its knowledge of where on the touch-pad or touch-screen the touch is detected to limit where it needs to look for the touchless movement. Thus in a set of embodiments wherein the first input means comprises a touch-pad or touch-screen which is able to detect the location of a user's touch, the second input means is configured to detect movement of the second digit within a region of based on said location. In a preferred exemplary implementation where the second input means comprises means for analysing impulse responses, in accordance with the set of embodiments above it may analyse only the impulse response taps corresponding to part of each timeframe corresponding to a time of flight for echoes from a spatial region near to the detected touch location. For example if the input being looked for is movement of a thumb on the same hand on which the index finger is touching the screen, there will be a relatively small spatial region in which a thumb could be located if the finger is known to be in a given place on the touch-pad or touch-screen. Where multiple channels are employed, this allows more precise narrowing of the spatial region by applying a suitable criterion to each channel. This feature may be applied to any device but is of greater benefit to devices with larger touch-pads or touch-screens—e.g. tablet computers.

The electronic device could be any of a wide variety of possible devices, for example a hand-held mobile device such as a smart phone or a stationary device. The device could be self-contained or merely an input or controller module for another device—thus it could be a remote control device for a piece of equipment to a games controller.

Certain embodiments of the invention will now be described, by way of example only, with reference to the accompanying drawings in which:

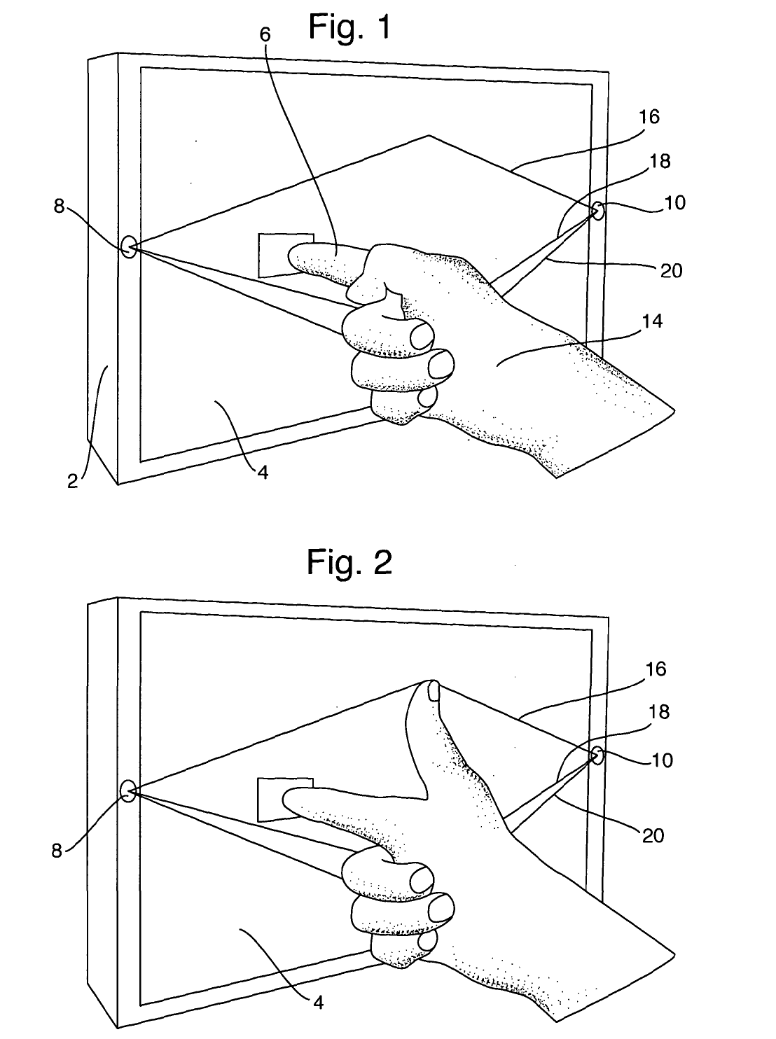

FIG. 1 is a schematic illustration of a user's hand touching a touch-screen;

FIG. 2 is a schematic illustration similar to FIG. 1 in which the user's thumb has been moved;

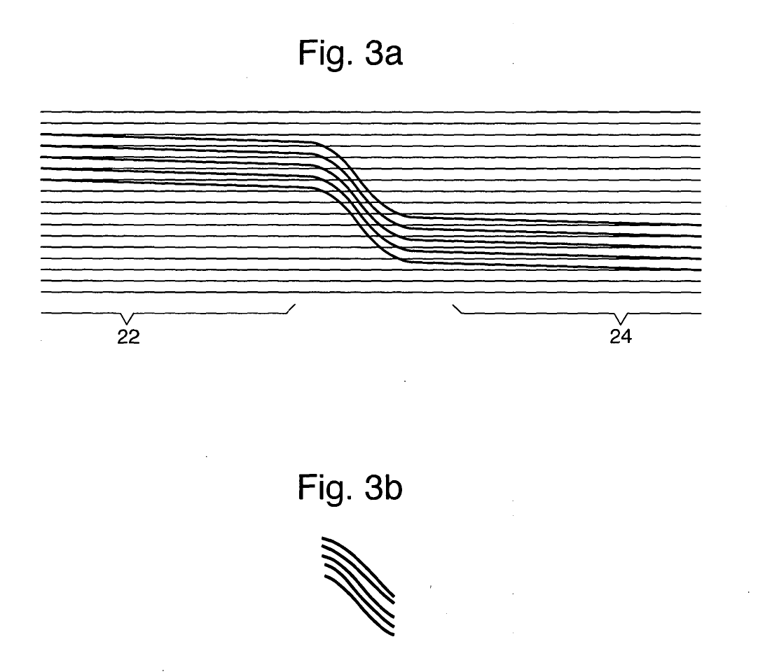

FIG. 3a; is a schematic representation of an impulse response image corresponding to the movement between FIGS. 1 and 2;

FIG. 3b is a representation of the impulse response image after application of a suitable line filter;

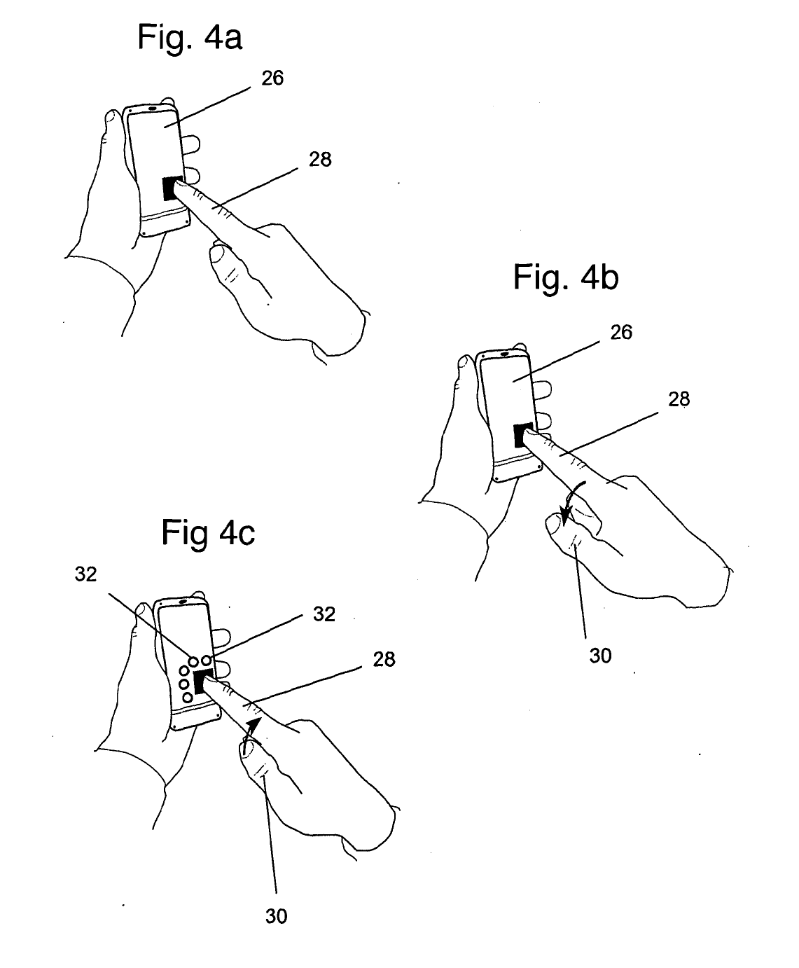

FIGS. 4a to 4c show a possible user interface enabled by an embodiment of the invention;

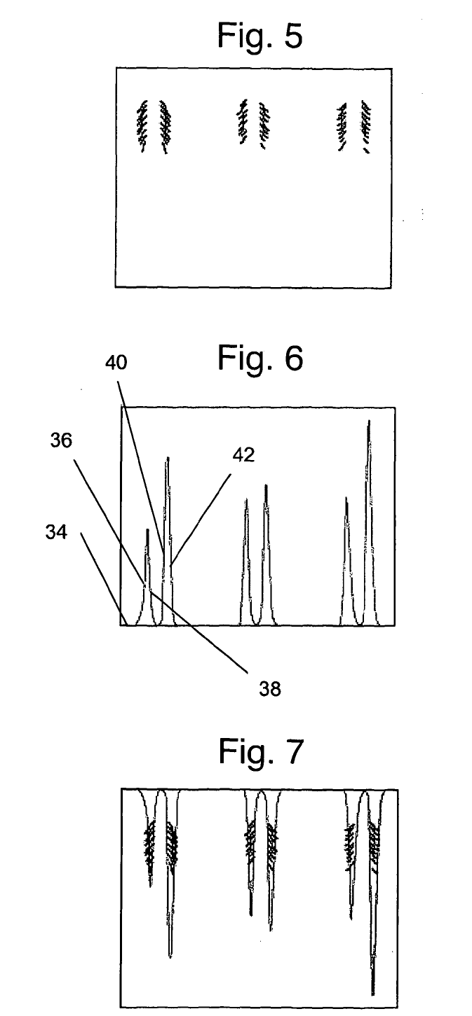

FIG. 5 shows an impulse response image corresponding to the movement of a user's thumb shown in FIGS. 4b and 4c;

FIG. 6 shows a plot of data extracted from the impulse response image of FIG. 5; and

FIG. 7 shows FIG. 6 overlaid onto FIG. 5.

Turning first to FIG. 1, there may be seen an electronic device which could be any touch-screen operated device such as a tablet computer. The device comprises a touch-sensitive screen 4 covering most of its front face, the touch-screen 4 being able to detect the presence and location of a touch by a user's finger 6. At the left and right side respectively of the touch screen 4 are a loudspeaker 8 and a microphone 10 which are provided as an integral part of the tablet computer 2. Although these components are designed for transmitting and receiving lower frequency audible sounds used in other operations of the computer, their range of operation extends significantly—e.g. to more than 17 kHz and beyond to ultrasonic frequencies (i.e. above 20 kHz).

In operation of the device 2, normally the touch-screen 4 is in an active state in which it is ready to receive touch inputs but the speaker 8 and microphone 10 are either not used or are used for ordinary audible sound purposes only. However, when the touch of a user's finger 6 is detected on the touch screen 4 the loudspeaker 8 begins to transmit a series of short, regularly spaced pulses of ultrasound. At this point the software also begins to process ultrasonic signals received by the microphone 10. The pulses can be transmitted simultaneously with any audible sound reproduction which the speaker 8 is required to give. Given the diffractive nature of ultrasound, despite the fact that the speaker 8 is flush with the front face of the device 2, the sound emanates from it in all directions. Three exemplary paths travelled by sound from the loudspeaker 8, via reflection from the user's hand 14 and reception by the microphone 10 are shown by respective lines 16, 18 and 20.

The uppermost line 16 shows the path of ultrasound energy from the speaker 8 via a glancing reflection from the user's thumb knuckle to the microphone 10. The other two lines 18, 20 show different paths for sound energy which is reflected from the fronts of the fingers which are not extended (the actual points from which the energy is reflected are obscured in these figures). The signals received by the microphone 10 are converted into digital signals and are then analysed as will be described in greater detail hereinbelow.

Turning to FIG. 2, it may be seen that the user has moved his thumb up so that there is a different reflection of energy 16′ now from the tip of the thumb which has a significantly different time of flight as compared to the path of the uppermost reflection 16 depicted in FIG. 1.

FIGS. 3a and 3b show the signals received by the microphone 10 after transformation to an impulse response image. The formation of such images is described in greater detail in the applicant's earlier patent publications, e.g. WO 2009/115799. The images are therefore essentially a plot of the signals received within a given time slot (the length of time between respective signal pulse transmissions) along the vertical axis with consecutive time slots arranged adjacent to one another along the horizontal axis.

FIG. 3a shows the basic impulse responses received. As mentioned earlier, if the transmitted signals are very short, Dirac-like pulses, a calculation of impulse responses may not be necessary. It can be seen from FIG. 3a that there are many, closely spaced lines, each corresponding to the reflection of the transmitted signals from a different part of the hand. However, amongst the myriad of substantially horizontal lines, there can be seen a set of diagonal lines. These diagonal lines represent the transition between the first phase 22 corresponding to the configuration of the hand in FIG. 1 and the second phase 24 corresponding to the configuration of the hand in FIG. 2. The diagonal lines inbetween represent the movement of the user's thumb between these two positions. By applying a relatively crude filter to the impulse response image shown in FIG. 3a, e.g. to remove any lines which are below a threshold gradient, an image like that in FIG. 3b can be obtained. A simple test can then be applied to determine whether or not to interpret this as a “thumb click” gesture, e.g. by determining whether there is more than a threshold amount of energy remaining after application of the filter. Since detection of the movement need only be made during or shortly after a physical touch, it can afford to be a relatively sensitive detection as there is a very low risk of other movements giving false inputs.

If the device detects a thumb-click gesture, it may respond in any appropriate way. For example, it may act to select or action an icon highlighted by the user's finger 6. Alternatively it could be used to bring up a context sensitive menu in a manner similar to a traditional right mouse click.

The loudspeaker 8 continues transmitting the pulsed ultrasound signals as long as the user's finger 6 remains in contact with the touch-screen 4. This allows multiple inputs to be received. However, as soon as the user removes his finger from the touch-screen, the ultrasound transmissions from the speaker 8 are ceased in order to conserve battery power.

FIG. 4a shows a smart-phone having a touch-screen 26 being touched by a user's finger. After this is detected the phone starts to emit ultrasonic chirp signals as previously described and these are used to detect an outward movement of the user's thumb 30 as shown in FIG. 4b. The way in which this is detected from the corresponding impulse response image is explained below with reference to FIGS. 5 to 7.

After the outward movement is detected, another inward movement is detected by the device. The combination of the touch and the two movements of the thumb cause the device to display a number buttons 32 on its screen to provide access to further options which are not available by touch alone. The user may touch any of these buttons to select the additional functionality. The detection of the thumb movement will be described in greater detail hereinbelow.

The detection of an input to the device is based on the principle that even small movements in the vicinity of the screen 26 give rise to detectable differences in the echo environment, i.e. the impulse response image. By repeatedly transmitting the same waveform over time, movements can be detected by comparing the differences in the received signal.

Specifically, suppose the same waveform is emitted at time tₖ₋₁ and tₖ. If it is assumed that there is no movement in the echo field during this time then

rₖ(t)≈rₖ₋₁(t)

where rₖ(t) is the received signal at time tₖ+t. Conversely, if there is movement in the same time interval then

rₖ(t)≠rₖ₋₁(t)

The magnitude of the difference signal rₖ(t)−rₖ₋₁(t) is therefore an indicator of motion at time tₖ. As an example the accumulated energy:

Eₖ=∫_{τ}_{ₛ}^{τ}^{_{b}}[rₖ(t)−rₖ₋₁(t)]²dt (1)

can be used as a statistical measure against which tests can be made. Here τₛ and τ_{b} are appropriate integration limits to be defined below. More generally detection can be based on the difference signal rₖ(t)− r̅ₖ(t) where r̅ₖ(t) is an estimate of the background at time tₖ. The signal r̅ₖ(t) will typically be a function of the previous received signals rₖ₋₁(t), rₖ₋₂(t), . . . such as a running average or median. In its simplest form r̅ₖ(t)=rₖ₋₁(t).

Desirably only movement close to the screen should trigger a detection. This can be achieved by making use of the fact that echoes from reflectors further away from the screen will arrive later in time. Thus, the distance limitation can be applied by using only the signals received during a short interval after each transmission.

In general the time of flight—i.e. the combined speaker-reflector-microphone distance—should be limited to some maximum distance dₘₐₓ

Given a transmission at time tₖ this implies that only signals received during the interval:

$$( {t}_{k} , {t}_{k} + \frac{{d}_{max}}{C} + {T}_{p} )$$

are used as the basis for detection. Here c denotes the speed of sound while Tₚ is the length of the emitted waveform. This can be integrated into equation (1) by setting the integration limits to τₛ=0 and

$${τ}_{b} = \frac{{d}_{max}}{C} + {T}_{p}$$

For detection purposes the length of the transmitted waveform Tₚ can be assumed to be short. This is either because short pulses are emitted directly, or because pulse-compression is performed on the receive side prior to detection.

The time difference between consecutive transmissions is of the order of milliseconds. Thus, the time span of any consistent movement would entail the emission of several waveforms (pings). A movement is therefore inferred on the basis of a data derived from a sequence of measurements

. . . , Eₖ,Eₖ₊₁,Eₖ₊₂,

as opposed to a single Eₖ alone.

A simple rule for a positive detection might be Eₖ₊ᵢ>E_{threshold} consistently for i=0, 1, . . . N and N is chosen to match the typical time span of a motion event.

However in this example a more particular user movement is required to activate the virtual buttons: it requires that one finger should touch the screen while another finger should move back and forth in quick succession. This will have the effect that there is an apparent drop in movement when the moving finger is changing direction, thus leaving a characteristic signature on the sequence

. . . , Eₖ,Eₖ₊₁,Eₖ₊₂, (2)

The rule applied (once a finger is detected as being placed on the screen) is that the following five steps must be satisfied within a predefined time span:
1. The sequence {Eₖ} is below a threshold E_{threshold}⁽¹⁾ (there is initially no movement)
2. The sequence rises above a threshold E_{threshold}⁽²⁾ (the finger is moving in one direction)
3. The sequence falls below a threshold E_{threshold}⁽³⁾ (there is a change in direction)
4. The sequence rises above a threshold E_{threshold}⁽⁴⁾ (the finger is moving back)
5. The sequence falls below a threshold E_{threshold}⁽⁵⁾ (the finger is coming to rest)

Application of the algorithm set out above will now be described.

FIG. 5 shows an impulse response image (IRI) corresponding to three repetitions of the out and in movement of a user's thumb as shown in FIGS. 4b and 4c after a background subtraction. The background subtraction is here carried out by subtracting the previous column from each column, however more refined methods can also be applied

The sum-of-square calculation set out above with reference to Eq (1) is then carried out, which results in the plot shown in FIG. 6. This plot is shown overlaid on the IRI in FIG. 7 for reference.

The plot in FIG. 6 is used to carry out detection of the thumb movement. Taking the left-most instance of the movement, the software first detects the portion 34 in which the energy is below a first threshold indicating that there is no movement (step 1 above). It then detects the point 36 at which the energy represented increases above a threshold (step 2). Next the energy is detected to fall below another threshold at point 38 (step 3), before rising again above a fourth threshold at point 40 (step 4). Finally the energy falls back below a fifth threshold at point 42 (step 5). If these steps are all detected in the correct sequence, the software indicates detection of the thumb movement and thus displays additional buttons as previously described.

It should be appreciated that the detailed embodiment described above is merely an example of how the principles of the invention may be implemented. There are many possible modifications and variations within the scope of the invention. For example, there are a variety of different gestures which could be detected and the method of detection could be one of a number of possibilities known per se in the art. Although the movement detection is made whilst the finger is touching the screen, it could be made within a short time after the touch is finished. The described embodiment does however demonstrate that a convenient and intuitive additional user input functionality can be provided for an electronic device with a touch-screen without requiring significant hardware modifications. Moreover the nature of the touch may determine what functions are available from the non-touch movement, further extending the available functionality.

1. An electronic device comprising: a first input means adapted to detect that a first digit of a user's hand is in contact with the device; and a second input means adapted to detect movement of a second digit of the user's hand which is not in contact with the device, wherein the device is configured to respond to detection of said movement by said second input means while said contact is detected by said first input means or within a predetermined time thereafter.

2. A device as claimed in claim 1 comprising an acoustic transmitting means and acoustic receiving means and being arranged to detect the motion of the second digit by receipt by the receiving means of an acoustic signal transmitted by the transmitting means and reflected from the second digit.

3. A device as claimed in claim 2 wherein said acoustic signal is ultrasonic and said transmitting means and/or said receiving means is also used by the device for transmission/reception of audible signals.

4. A device as claimed in claim 2 or 3 configured only to transmit the signal when the contact is detected by the first input means.

5. A device as claimed in claim 4 configured to transmit until the first input means no longer detects contact by the first digit.

6. A device as claimed in any of claims 2 to 5 configured only to process signals received by the receiving means when the contact is detected by the first input means.

7. A device as claimed in any of claims 2 to 6 wherein said transmitting means is arranged to transmit chirps.

8. A device as claimed in any preceding claim wherein the detections by the first and second input means are simultaneous.

9. A device as claimed in any preceding claim wherein the first input means comprises a physical or virtual button which detects pressure or touch from a user's finger in a single place.

10. A device as claimed in any of claims 1 to 9 wherein the first input means comprises a touch-pad or touch-screen which is able to detect the location of the user's touch.

11. A device as claimed in claim 10, wherein the first input means comprises a touch-screen comprising an integrated display screen.

12. A device as claimed in any preceding claim configured to respond differently to a given movement of the second digit depending on the nature of the contact by the first digit.

13. A device as claimed in any preceding claim arranged to detect motion of the second digit comprising a rotary motion of the second digit around the first digit.

14. A device as claimed in any preceding claim arranged to detect a movement of the second digit in the direction towards or away from the first digit.

15. A device as claimed in any preceding claim comprising a touch-pad or touch-screen which is able to detect the location of a user's touch, wherein the second input means is configured to detect movement of the second digit within a region of based on said location.

16. A device as claimed in claim 15 wherein the second input means comprises means for analysing impulse responses, and arranged to analyse only impulse response taps corresponding to part of each timeframe corresponding to a time of flight for echoes from a spatial region near to the detected touch location.

17. An electronic device comprising: a first input means adapted to detect that at least part of a user's hand is in contact with the device; and a second input means adapted to detect movement of at least part of a user's hand which is not in contact with the device, wherein the device is configured to respond to detection of said movement by said second input means differently depending on whether said contact with the device is detected by said first input means before said movement is detected.

18. A device as claimed in claim 17 comprising an acoustic transmitting means and acoustic receiving means and being arranged to detect the motion of the second digit by receipt by the receiving means of an acoustic signal transmitted by the transmitting means and reflected from the second digit.

19. A device as claimed in claim 18 wherein said acoustic signal is ultrasonic and said transmitting means and/or said receiving means is also used by the device for transmission/reception of audible signals.

20. A device as claimed in claim 18 or 19 comprising a single channel for detecting motion of said second digit.

21. A device as claimed in any of claims 18 to 20 wherein said transmitting means is arranged to transmit chirps.

22. A device as claimed in any of claims 17 to 21 wherein the detections by the first and second input means are simultaneous.

23. A device as claimed in any of claims 17 to 22 wherein the first input means comprises a physical or virtual button which detects pressure or touch from a user's finger in a single place.

24. A device as claimed in any of claims 17 to 22 wherein the first input means comprises a touch-pad or touch-screen which is able to detect the location of the user's touch.

25. A device as claimed in claim 24, wherein the first input means comprises a touch-screen comprising an integrated display screen.

26. A device as claimed in any of claims 17 to 25 arranged to detect motion of the second digit comprising a rotary motion of the second digit around the first digit.

27. A device as claimed in any of claims 17 to 26 arranged to detect a movement of the second digit in the direction towards or away from the first digit.

28. A device as claimed in any of claims 17 to 27 comprising a touch-pad or touch-screen which is able to detect the location of a user's touch, wherein the second input means is configured to detect movement of the second digit within a region of based on said location.

29. A device as claimed in claim 28 wherein the second input means comprises means for analysing impulse responses, and arranged to analyse only impulse response taps corresponding to part of each timeframe corresponding to a time of flight for echoes from a spatial region near to the detected touch location.

30. A method of operating an electronic device comprising detecting that a first digit of a user's hand is in contact with the device using a first input means;
detecting movement of a second digit of the user's hand which is not in contact with the device using a second input means, and responding to detection of said movement by said second input means while said contact is detected by said first input means or within a predetermined time thereafter.

31. A method as claimed in claim 30 comprising detecting motion of the second digit by receiving at an acoustic receiving means an acoustic signal transmitted by an acoustic transmitting means and reflected from the second digit.

32. A method as claimed in claim 31 wherein said acoustic signal is ultrasonic the method further comprising using said transmitting means and/or said receiving means for transmission/reception of audible signals.

33. A method as claimed in claim 31 or 32 comprising transmitting the signal when the contact is detected by the first input means.

34. A method as claimed in claim 33 comprising transmitting until the first input means no longer detects contact by the first digit.

35. A method as claimed in any of claims 31 to 34 comprising only processing signals received by the receiving means when the contact is detected by the first input means.

36. A method as claimed in any of claims 31 to 35 comprising transmitting chirps.

37. A method as claimed in any of claims 30 to 36 comprising detecting using the first and second input means simultaneously.

38. A method as claimed in any of claims 30 to 37 wherein the first input means comprises a touch-pad or touch-screen the method comprising detecting the location of the user's touch.

39. A method as claimed in claim 38 wherein the first input means comprises a touch-screen comprising an integrated display screen.

40. A method as claimed in any of claims 30 to 39 comprising responding differently to a given movement of the second digit depending on the nature of the contact by the first digit.

41. A method as claimed in any of claims 30 to 40 comprising detecting motion of the second digit comprising a rotary motion of the second digit around the first digit.

42. A method as claimed in any of claims 30 to 41 comprising detecting a movement of the second digit in the direction towards or away from the first digit.

43. A method as claimed in any of claims 30 to 42 wherein the device comprises a touch-pad or touch-screen the method comprising detecting the location of a user's touch on the touch-pad or touch-screen, and the second input means detecting movement of the second digit within a region based on said location.

44. A method as claimed in claim 43 comprising analysing only impulse response taps corresponding to part of each timeframe corresponding to a time of flight for echoes from a spatial region near to the detected touch location.

45. Computer software, preferably on a carrier or other computer readable medium, which is adapted, when run on suitable data processing means, to:
receive a first signal from a first input means of an electronic device indicating a detection that a first digit of a user's hand is in contact with the device;
receive a first signal from a second input means of the electronic device indicating a detection of a movement of a second digit of a user's hand which is not in contact with the device; and
provide a response in the event that said movement of the user's second digit is detected while said contact by the first digit is detected or within a predetermined time thereafter.

46. Software as claimed in claim 45 adapted to carry out a method as claimed in any of claims 31 to 44.
